(19) United States
(12) Patent Application Publication
(10) Pub. No.: US 2017/0163559 A1
(43) Pub. Date: Jun. 8, 2017

(54) DISTRIBUTION SYSTEM AND METHOD FOR CONTROLLING THE SAME

(71) Applicant: CANON KABUSHIKI KAISHA, Tokyo (JP)

(72) Inventor: Keita Oshima, Tokyo (JP)

(21) Appl. No.: 15/364,792

(22) Filed: Nov. 30, 2016

(30) Foreign Application Priority Data
Dec. 4, 2015 (JP) 2015-237128

(51) Int. Cl. H04L 12/911; H04L 12/24; H04L 29/08

(52) U.S. Cl. CPC H04L 47/781; H04L 67/32; H04L 41/22

(57) ABSTRACT

In a case where a distribution system receives a distribution setting request for a content via WebAPI, the distribution system determines whether to permit the distribution setting based on information about a service which has requested the distribution setting, a status of a content distribution target device subjected of the distribution setting, information about the content to be distributed based on the distribution setting, and a distribution condition set in advance. In a case where the distribution system determines to permit the distribution setting, the distribution system applies the distribution setting. On the other hand, in a case where the distribution system determines not to permit the distribution setting, the distribution system cancels the distribution setting.

### BACKGROUND

Field of the Disclosure

The present disclosure relates to a distribution system for controlling distribution of a content to a device and to a method for controlling the distribution system.

Description of the Related Art

Conventionally, to maintain a favorable operating state of a device, such as a multi-functional peripheral, the device is connected to a monitoring service and the device status is monitored from the monitoring service side. Accordingly, in the event that such trouble as a failure or frequent jam is detected in the device, for example, a service engineer can be promptly dispatched for troubleshooting. If the monitoring service detects that the life of a consumable will soon end, the monitoring service performs processing for shipping the consumable to enable maintaining user's inventory consumables to suitable quantities. Such a monitoring service is provided by development companies or direct-sales companies of devices.

Meanwhile, in recent years, devices are also connected to a Managed Print Service (MPS) which is an outsourcing service for analyzing the present state of the office output environment of a company and proposing and configuring an optimal output environment. In the MPS, a plurality of makers of devices configuring the company environment may be involved, and services may be provided from companies other than development companies or direct-sales companies of devices.

Each device is connected to a distribution system which performs, via a network, remote distribution of software to be installed in the device and automatic update of the software. The device is maintained so that the software of the latest version or a suitable version operates thereon. Each device can utilize two different types of software: firmware for implementing original built-in functions and applications installed and used afterwards by each user. The above-described distribution system is provided by the development company of the device.

As for household appliances, there is proposed a technique for automatically recovering failures by transmitting product information to a management server and upgrading software of a product conforming to management information (Japanese Patent Application Laid-Open No. 2002-91842).

To connect with various services provided via a network and cooperatively operate with them, a management agent associated with the services is installed and operating on each device. For example, to cooperate with a management service for collecting and totalizing device information, a management agent for transmitting device information to a service on the network is required. In addition to cases of management services, there are cases where agent software for cooperating with an external system may be installed and where functions included in firmware may be enabled to extend device functions.

In not only a distribution system but also a case in which a plurality of services is connected to a device in such a way, each service is demanded for the following points to suitably maintain the state of cooperation with the device. More specifically, even for services other than those in the distribution system, remote distribution of software is desired to be performed so that software or functions installed and operating on the device are maintained to suitable versions.

Accordingly, the distribution system is configured to provide an Application Programming Interface (API) for performing a distribution setting from external to receive distribution setting requests from these services.

However, there has been an issue that, since the distribution system receives distribution settings from a plurality of services, the distribution system side needs to control reception of requests so that a distribution setting is not performed on devices which is not a management target of a service by requests from other services.

### SUMMARY

According to one or more aspects of the present disclosure, a distribution system for controlling distribution of a content to a device according to a distribution setting requested from one or more of services which manages devices, the distribution system includes a first receiving unit configured to receive a request of a distribution setting for a content from a service capable of communicating via a network, a determination unit configured to, in a case where the first receiving unit receives the request for the content from the service, determine whether to permit the distribution setting based on information of the service which has requested the distribution setting, a status of a content distribution target device of the distribution setting, and a distribution condition set in advance, and a control unit configured to perform control, in a case where the determination unit determines to permit the distribution setting, to apply the distribution setting, and to perform control, in a case where the determination unit determines not to permit the distribution setting, to cancel the distribution setting.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a system to which a distribution system according to one or more aspects of the present disclosure.

FIG. 2 is a diagram illustrating a hardware configuration of an application server of the distribution system.

FIG. 3 is a diagram illustrating a functional configuration of the distribution system and a device.

FIG. 4 is a sequence diagram illustrating an example of a communication sequence of the distribution system from a management service based on a distribution setting device list.

FIG. 5 is a sequence diagram illustrating an example of a communication sequence of the distribution system from the management service based on a distribution setting request (an example for applying a distribution setting).

FIG. 6 is a sequence diagram illustrating an example of a communication sequence of the distribution system from the management service based on a distribution setting request (an example for disabling a distribution setting).

FIG. 7 is a flowchart illustrating an example of processing for determining whether to perform a distribution setting in the distribution system.

### DESCRIPTION OF THE EMBODIMENTS

One or more aspects for embodying the present disclosure will be described below with reference to the accompanying drawings.

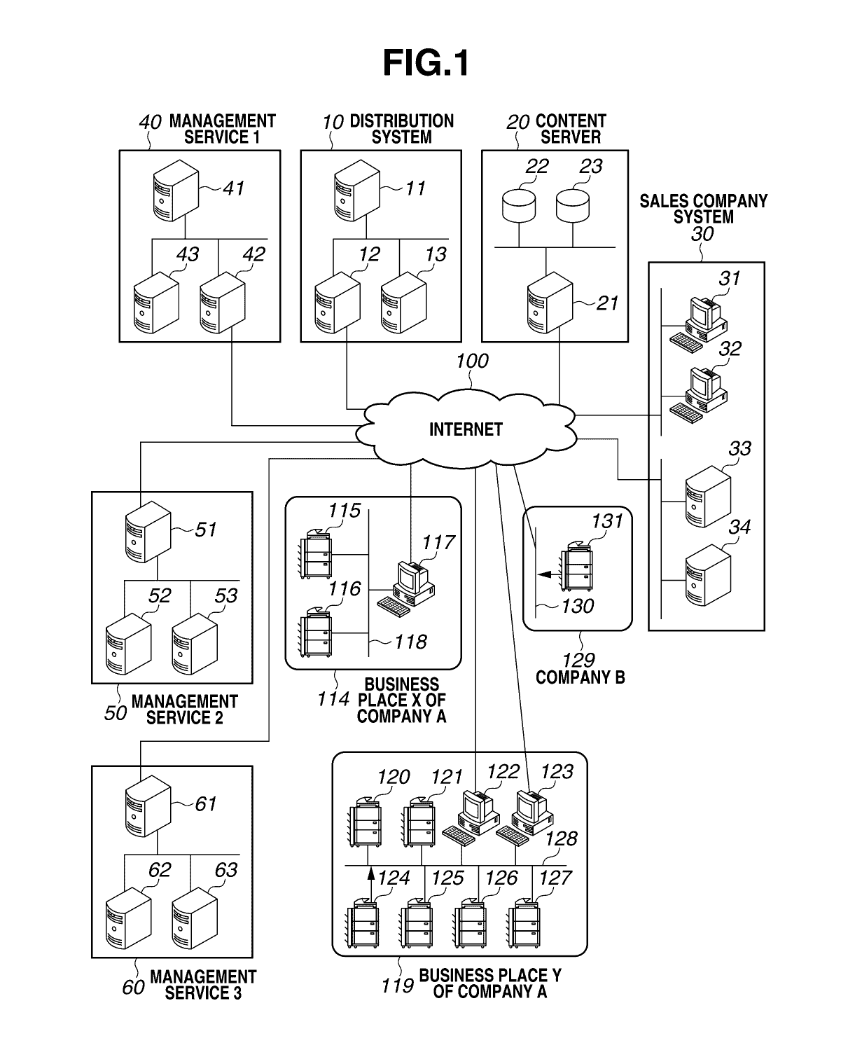

FIG. 1 is a diagram illustrating a configuration of a system to which a distribution system according to one or more aspects of the present disclosure.

Referring to FIG. 1, a distribution system 10 includes a web server 12, a database (DB) server 13, and an application server 11. The distribution system 10 communicates with devices 115 to 117, 120, 121, 124 to 127, and 131 of customer companies 114, 119, and 129 via the web server 12 connected to the Internet 100. Thus, the distribution system 10 controls distribution of application software (hereinafter simply referred to as an “Application”) and firmware (hereinafter simply referred to as “FW”) to one or a plurality of devices.

The distribution system 10 can receive a distribution setting from a web browser via a network. The distribution system 10 can also perform distribution control in response to a distribution setting request from a management service 2 (50) and a management service 3 (60).

Actual files of applications and FW are arranged on a content server 20. When installing an application on a device, the device acquires position information (for example, a Uniform Resource Locator (URL)) of the actual file on the content server 20 from the distribution system 10 and downloads the application from the content server 20. This enables deconcentrating the load of application distribution for many devices and efficiently distributing applications. This also applies update of applications and FW.

The content server 20 includes a content management server 21 and file storages 22 and 23. The content management server 21 stores or provides file contents, i.e., actual files of applications and FW in response to requests from the outside.

A device refers to, for example, a multi-functional printer (MFP) or a single function printer (SFP) and is provided with one or a plurality of functions for each device model. Functions of a device become usable when the FW for implementing these functions is installed in the device. An application executable for each device model or commonly executable for device models can be installed and executed. The user of a device selects a desired application from a plurality of applications usable on the device and purchases the license of the application. Then, the user can install the application. When trouble of an application of a device is corrected or functions are improved or added, updating the application enables using these functions.

A sales company system 30 is used by device manufacture companies or device sales companies selling devices to customer companies 114, 119, and 129 and maintaining and managing the devices to perform operations for registering and managing applications and FW. The sales company system 30 includes one or a plurality of personal computers (PCs) 31 and 32 or servers 33 and 34. Through access from the sales company system 30 to the distribution system 10 and the content server 20, applications and FW can be registered and a distribution setting is performed.

A management service 1 (40) is used by sales companies or manufacture companies to maintain customer's devices. The management service 1 (40) includes a web server 42, a database (DB) server 43, and an application server 41. The management service 1 (40) connects with customer's devices, which are management targets, via the Internet 100 to collect information from each device. A service engineer accesses the management service 1 (40) from the sales company system 30 to perform information collection and status monitoring required to maintain customer's devices.

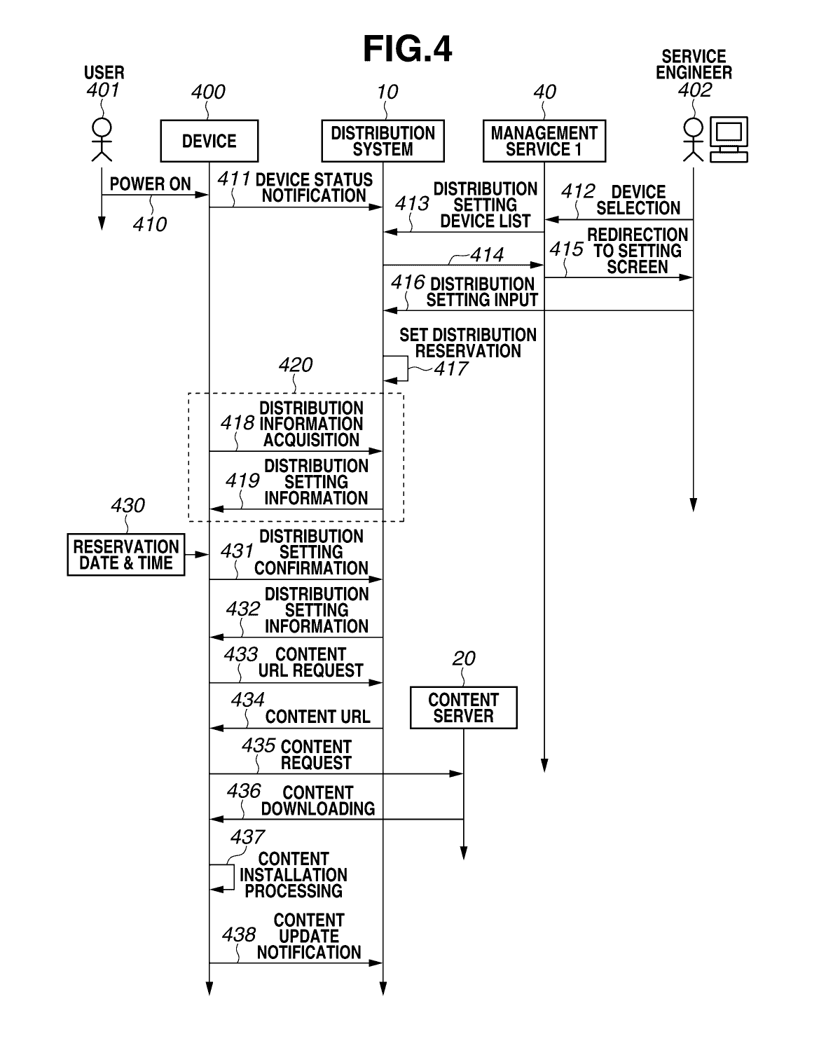

The management service 1 (40) has a cooperation function of closely cooperating with the distribution system 10. With the cooperation function, for example, the management service 1 (40) transmits a list of devices, selected from management target devices by a web client, such as a web browser, to the distribution system 10 to enable the device list to be shared with the distribution system 10. The management service 1 (40) further leads the web client to, as an access destination, a web user interface provided by the distribution system 10 by using such a method as redirection. Accordingly, a distribution setting of a content to be distributed to the each device specified in the device list can be input from the web user interface. The management service 1 (40) will be described in detail below with reference to FIG. 4.

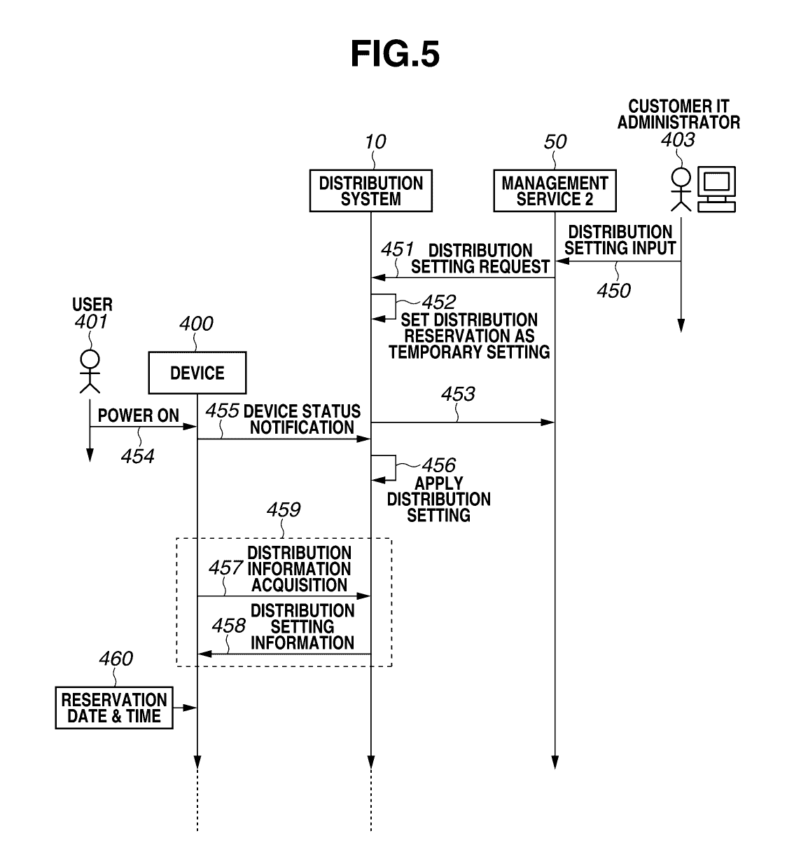

The management service 2 (50) and the management service 3 (60) are used by an information technology (IT) administrator of customers or a service engineer of sales companies entrusted by the customers to maintain customer's devices. The management service 2 (50) and the management service 3 (60) have a similar configuration to that of the management service 1 (40). The management service 2 (50) and the management service 3 (60) connects with management target devices of the customer via the Internet 100 to collect information from each device. The IT administrator of the customer or the service engineer accesses a management service 2 (50) and a management service 3 (60) to perform information collection and status monitoring required to maintain customer's devices. The management service 2 (50) and the management service 3 (60) transmit a distribution setting request to the distribution system 10 to request a distribution setting of a content in the distribution system 10. These services will be described in detail below with reference to FIGS. 5 to 7.

In this way, one or a plurality of services for managing devices is connected with the distribution system 10 via the Internet 100 so that they can communicate with the distribution system 10. The distribution system 10 controls distribution of contents to clients according to requests from one or a plurality of services for managing these devices as clients.

Although, in the present exemplary embodiment, a MFP and a SFP are described as examples of devices to which the distribution system 10 distributes a content, content distribution target devices are not limited thereto. More specifically, the technique according to the present disclosure is effective for devices in a mechanism for managing each device by using one or a plurality of management services while applications are automatically distributed by a distribution system. Other examples of devices with which the present disclosure is effective include network cameras, personal computers, various types of household appliances connected to the Internet, vehicles mounting a plurality of electronic control apparatuses, and mobile phones.

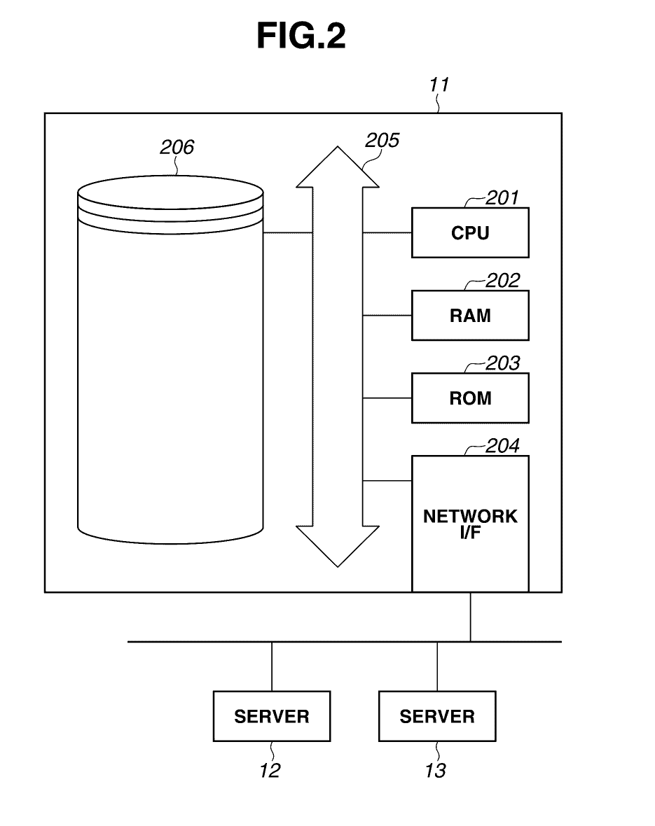

FIG. 2 is a block diagram illustrating a hardware configuration of the application server 11 of the distribution system 10 according to the present exemplary embodiment.

The application server 11 according to the present exemplary embodiment is mutually connected with the web server 12 and the DB server 13 via a network interface (I/F) 204. The application server 11 includes a central processing unit (CPU) 201, a random access memory (RAM) 202, a read only memory (ROM) 203, the network I/F 204, and a hard disk drive (HDD) 206 connected via a bus 205.

The function of the distribution system 10 is implemented when the CPU 201 reads data and a program recorded in the HDD 206, the ROM 203, and the RAM 202 of the application server 11 and then executes a program. The function of the distribution system 10 may be implemented through the cooperation of functions of a plurality of servers. The network I/F 204 is used for functional cooperation between servers in the distribution system 10 and is also used to communicate with an external system via the Internet 100.

Although FIG. 2 illustrates the configuration of the application server 11, other servers and controller units of devices have a similar hardware configuration. Therefore, illustration of others will be omitted.

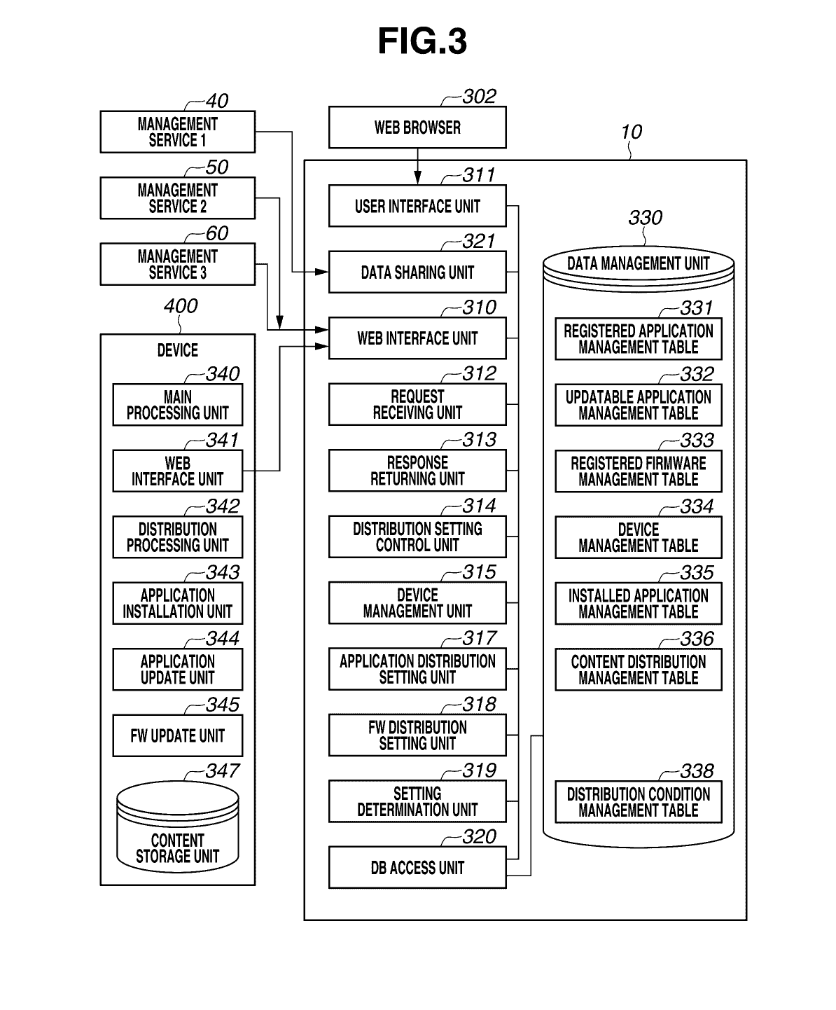

FIG. 3 is a block diagram illustrating a functional configuration of the distribution system 10 according to the present exemplary embodiment.

Since the distribution system 10 includes a plurality of servers as illustrated in FIG. 1, the functions are also assumed to have been implemented by the combination of a plurality of servers. However, the configuration of the distribution system 10 is not limited to the configuration illustrated in FIG. 1. All functions of the distribution system 10 may be implemented by one server or, when higher performance is required, by the combination of a plurality of servers.

Referring to FIG. 3, a device 400 is an example of a device connected to the distribution system 10. A web browser 302 is a client system as an example of a sales company system connected to the distribution system 10.

In the distribution system 10, a web interface unit 310 provides a function of distributing applications and FW to the device 400. The web interface unit 310 receives various requests from each device and returns a processing result. For example, upon reception of a distribution information request for a content, such as FW and an application, the web interface unit 310 searches for a location where the target content is stored and returns a URL for acquiring the content. The web interface unit 310 receives a request based on an API (Web Application Programming Interface, hereinafter referred to as WebAPI) for performing a distribution setting from an external system, such as the management service 2 (50) and the management service 3 (60) and then performs a distribution setting.

A request receiving unit 312 receives a request from the web interface unit 310. A response returning unit 313 returns a response to the web interface unit 310.

A user interface unit 311 is used by the web browser 302 to access the distribution system 10 for registration of an application and FW and processing of a distribution setting.

A data sharing unit 321 receives a list of devices, selected from management target devices of a management service (the management service 1 (40) according to the present exemplary embodiment) having the above-described cooperation function, from the management service and shares the list with the management service.

A distribution setting control unit 314 controls a distribution setting of FW and applications. The distribution setting control unit 314 controls a device management unit 315, an application distribution setting unit 317, and a FW distribution setting unit 318 and determines the output content of a screen for a distribution setting to be displayed on the user interface unit 311. The distribution setting control unit 314 further controls a distribution setting from an external system.

A setting determination unit 319 determines whether a distribution setting based on a distribution setting request from an external system is possible. Depending on the result of the determination by the setting determination unit 319, the setting determination unit 319 controls the distribution setting control unit 314 to temporarily schedule a distribution setting and applies a distribution setting. This processing will be described in detail below.

A DB accessing unit 320 updates or searches for data in tables managed by a data management unit 330 according to various processing.

The data management unit 330 includes a registered application management table 331 (an example is illustrated in Table 3 described below), an updatable application management table 332 (an example is illustrated in Table 4 described below), and a registered firmware management table 333 (an example is illustrated in Table 5 described below).

The data management unit 330 further includes a device management table 334 (an example is illustrated in Table 6 described below) for storing device statuses, such as enabled functions in devices subjected to distribution management by the distribution system 10. The data management unit 330 further includes an installed application management table 335 (an example is illustrated in Table 7 described below) for storing information of applications and versions installed in devices subjected to distribution management by the distribution system 10. The data management unit 330 further includes a content distribution management table 336 (an example is illustrated in Table 8 described below) and distribution condition management tables 338 (examples are illustrated in Tables 1 and 2 described below).

The functional configuration of the device 400 will be described below.

A main processing unit 340 processes original functions of the device 400. When the device 400 is a printer, for example, the main processing unit 340 refers to a main function of performing, for example, image forming processing. In addition to the main function, the device 400 is provided with a function of performing distribution control for FW and applications of the device 400. Functional blocks 341 to 348 are units which perform distribution control.

The device 400 includes a web interface unit 341 for receiving distributed applications and FW from the distribution system 10. The web interface unit 341 is connected with the web interface 310 of the distribution system 10. The device 400 further includes a distribution processing unit 342, an application installation unit 343, an application updating unit 344, a FW updating unit 345, and a content storage unit 347 for storing distributed FW and applications.

An example of a processing flow in which an operator (the service engineer) performs a distribution setting on the distribution system 10 and the distribution system 10 distributes a content to the device 400 will be described below with reference to the sequence diagrams illustrated in FIGS. 4 to 6. In the sequence diagrams illustrated in FIGS. 4 to 6, processing of the distribution system 10 is implemented when the CPU 201 of the distribution system 10 executes a program stored in the HDD 206, the ROM 203, or the like. Processing of the device 400 is implemented, for example, when a CPU of the device 400 executes a program stored in an HDD or a ROM. Processing of the management service 1 (40) is implemented, for example, when a CPU of the management service 1 (40) executes a program stored in an HDD or a ROM. Processing of the management service 2 (50) is implemented, for example, when a CPU of the management service 2 (50) executes a program stored in an HDD or a ROM.

FIG. 4 is a sequence diagram illustrating an example of a processing flow in which the distribution system 10 distributes a content to the device 400 according to a distribution setting from the management service 1 (40).

Referring to FIG. 4, a user 401 is a user of the device 400. A service engineer 402 performs a remote distribution setting operation on the distribution system 10 to update applications and FW on the device 400. The sequence diagram illustrated in FIG. 4 indicates a case where the device 400 connects with the distribution system 10 before the service engineer 402 performs a distribution setting.

In step 410, the user 401 turns ON power of the device 400 to activate the device 400. In step 411, the device 400 notifies the distribution system 10 of the device status. The notified information includes information of applications installed in the device 400 and information of enabled built-in functions.

In step 412, to access the management service 1 (40) to perform a distribution setting of a content, the service engineer 402 specifies a list of distribution setting target devices including the device 400. In the preset exemplary embodiment, The service engineer 402 operates the user interface of the management service 1 (40) by using a web browser.

The management service 1 (40) transmits the list of devices specified by the service engineer 402 (distribution setting device list) to the distribution system 10 by using the data sharing unit 321. Upon reception of the distribution setting device list, then in step 414, the distribution system 10 transmits a response to the management service 1 (40). Upon reception of the response from the distribution system 10 in step 414, then in step 415, the management service 1 (40) returns to the web browser of the service engineer 402 a redirection instruction for changing the screen to a setting screen of the distribution system 10. In this case, the management service 1 (40) may transmit the above-described distribution setting device list as a parameter to the distribution system 10.

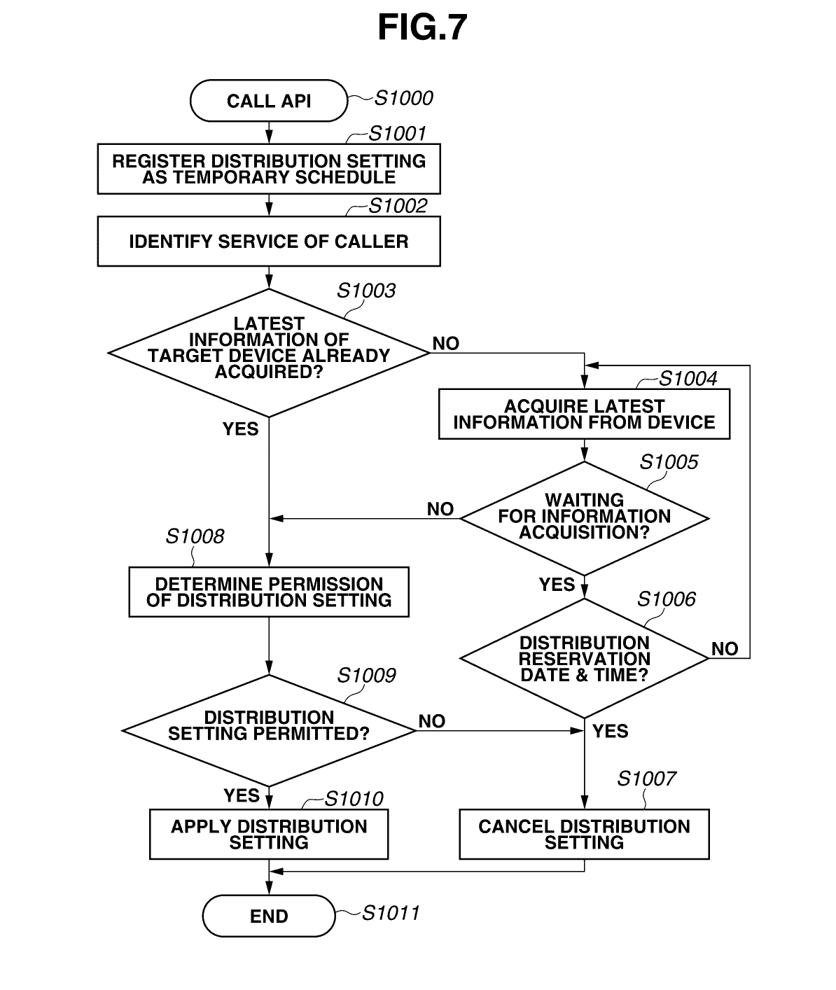

In step 416, from the setting screen of the distribution system 10 displayed according to the redirection instruction, the service engineer 402 inputs a distribution setting corresponding to each device to the distribution system 10. In this case, the distribution setting includes identification information of the distribution target devices specified in the above-described distribution setting device list, specification of the contents to be distributed, and scheduled distribution date and time. In step 417, the distribution system 10 stores the distribution setting to reserve distribution for each device specified in the above-described distribution setting. This distribution setting is based on the distribution setting device list received from the management service 1 (40) in step 413. The management target devices of the management service 1 (40) are specified as distribution target devices. Therefore, in the distribution setting, devices other than the management target devices of the management service 1 (40) are not specified as distribution target devices. This means that the management service 1 (40) is a reliable service and that this distribution setting is a reliable distribution setting. Therefore, the distribution system applies this distribution setting without performing determination as illustrated in FIG. 7 (described below). The distribution system 10 may apply the distribution setting, for example, according to the device status received from the device 400 in step 411. Further, the distribution system 10 may apply the distribution setting by performing determination as illustrated in FIG. 7 (described below).

In step sequence 420, the device 400, while being activated, periodically confirms with the distribution system 10 whether there is a distribution reservation. Step sequence 420 indicates a distribution setting confirmation sequence in which the device 400 periodically makes an inquiry to the distribution system 10. In step 418, at predetermined intervals or at a predetermined timing, the device 400 makes an inquiry to the distribution system 10 about whether there is a distribution setting for updating applications or updating FW for the device 400. When there is a distribution setting for updating applications or updating FW, then in step 419, the distribution system 10 transmits the information to the device 400 as a response. When there is a distribution setting, the device 400 stores the information from the distribution system 10 till the scheduled distribution date and time. The distribution setting information returned to the device 400 in step 419 includes distribution date and time information and distribution identification information.

When the above-described scheduled distribution date and time 430 comes, then in step 431, the device 400 transmits the distribution identification information to the distribution system 10 to confirm whether the distribution setting is enabled. When the distribution setting is enabled, then in step 432, the distribution system 10 returns the distribution setting information to the device 400. When the enabled distribution setting information is returned in step 432, then in step 433, the device 400 requests the distribution system 10 for the URL of the content to be distributed. In step 434, the distribution system 10 returns the URL of the content to be distributed to the device 400. In step 435, based on the URL of the content returned from the distribution system 10, the device 400 requests the content server 20 for the content. In step 436, the content server 200 downloads the requested content to the device 400.

In step 437, the device 400 performs processing for installing the downloaded content. When the downloaded content is FW, the device 400 updates FW. When the downloaded content is an application, the device 400 installs the application. Upon completion of the content installation processing in step 437, then in step 438, the device 400 notifies the distribution system 10 of the updating of the content. Upon reception of this update notification, the distribution system 10 updates the status information of the device 400, such as the version of FW updated or applications installed in the device 400.

A distribution setting sequence different from that illustrated in FIG. 4 will be described below with reference to FIG. 5.

FIG. 5 is a sequence diagram illustrating an example of a processing flow in which the distribution system 10 distributes a content to the device 400 in response to a distribution setting request from the management service 2 (50). In the following description, the management service 2 (50) may be replaced with the management service 3 (60).

Referring to FIG. 5, a user 401 uses the device 400 similar to the example illustrated in FIG. 4. A customer IT administrator 403 performs a remote distribution setting operation on the distribution system 10 to update applications and FW on the device 400. The sequence diagram illustrated in FIG. 5 indicates a case where the device 400 has not yet connected with the distribution system 10 when the customer IT administrator 403 performs a distribution setting. The management service 2 (50) transmits a distribution setting request via WebAPI to the distribution system 10 to perform a distribution setting.

In step 450, to access the management service 2 (50) to perform a distribution setting of a content, the customer IT administrator 403 specifies the device 400 and inputs a distribution setting. In this case, the customer IT administrator 403 operates the user interface of the management service 2 (50) by using a web browser.

In step 451, by using the web interface, the management service 2 (50) transmits a distribution setting request to the distribution system 10 based on the content of the above-described distribution setting specified by the customer IT administrator 403. In step 452, the distribution system 10 once stores the distribution setting corresponding to the received distribution setting request as a temporary setting for distribution reservation. In step 453, the distribution system 10 returns a WebAPI response to the management service 2 (50).

Subsequently, in step 454, the user 401 turns ON power of the device 400 to activate it. In step 455, the device 400 notifies the distribution system 10 of the device status. According to the information acquired in step 455, the distribution system 10 determines, via the setting determination unit 319, whether the distribution setting is permitted as illustrated in FIG. 7 (described below). In the example sequence illustrated in FIG. 5, in step 456, the distribution system 10 determines that the distribution setting is permitted and recognizes the temporary set distribution reservation as the applied distribution setting.

Similar to the sequence illustrated in FIG. 4, in step sequence 459, the device 400 periodically confirms with the distribution system 10 whether there is a distribution reservation. As illustrated in step sequence 459, in step 457, the device 400 makes an inquiry to the distribution system 10 about whether there is a distribution setting for updating applications or updating FW for the device 400. When there a distribution setting for updating applications or FW, in step 458, the distribution system 10 transmits the information to the device 400 as a response. When there is a distribution setting, the device 400 stores the information received from the distribution system 10 till the scheduled distribution date and time. The sequence after the reservation date and time 460 is similar to the sequence after step 431 illustrated in FIG. 4, and redundant descriptions thereof will be omitted.

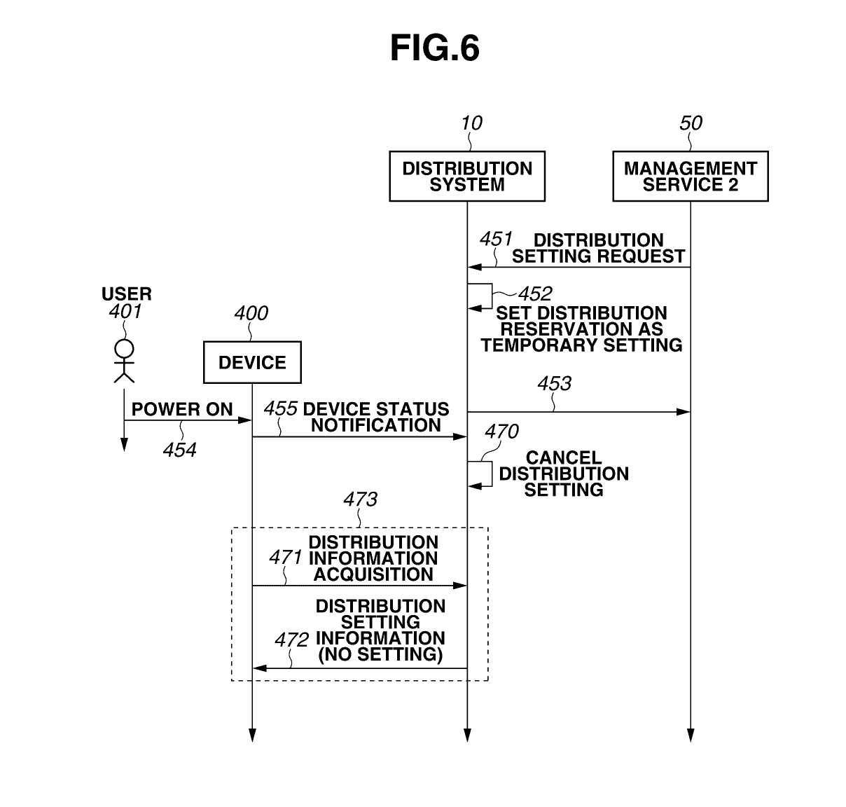

A distribution setting sequence different from the sequences illustrated in FIGS. 4 and 5 will be described below with reference to FIG. 6.

FIG. 6 is a sequence diagram illustrating an example of a processing flow in which the distribution system 10 disables a distribution setting in response to a distribution setting request from the management service 2 (50). Steps 451 to 455 illustrated in FIG. 6 are similar to those illustrated in FIG. 5, and redundant descriptions thereof will be omitted. In the following description, the management service 2 (50) may be replaced with the management service 3 (60).

According to the information acquired in step 455, the distribution system 10 determines, via the setting determination unit 319, whether the distribution setting is permitted as illustrated in FIG. 7. In the example sequence illustrated in FIG. 6, according to the information notified from the device 400, the distribution system 10 determines that the distribution setting for the device 400 from the management service 2 (50) cannot be permitted. More specifically, in step 470, the distribution system 10 cancels the temporary set distribution reservation according to the information acquired in step 455.

In step sequence 473, similar to the sequence illustrated in FIG. 5, the device 400 confirms whether there is a distribution reservation. As illustrated in step sequence 473, in step 471, the device 400 makes an inquiry to the distribution system 10 about whether there is a distribution setting for updating applications or FW for the device 400. However, in step 472, the distribution system 10 returns to the device 400 information indicating that there is no distribution setting for the device 400. Since there is no distribution setting for the device 400, the device 400 repeats periodically making an inquiry to the distribution system 10 until the next distribution setting is input.

As illustrated in FIGS. 5 and 6, based on the information acquired from the device 400, the distribution system 10 enables or disable distribution settings according to a request from the management service 2 (50) and processes only enabled distribution settings.

Also for the device list transmission by the management service 1 (40) and for the distribution setting on the setting screen of the distribution system 10 illustrated in FIG. 4, the distribution system 10 may determine whether a distribution setting is enabled or disabled.

The determination whether a distribution setting is enabled (permitted) or disabled (cancelled) by the setting determination unit 319 will be described below.

Tables 1 and 2 illustrate examples of distribution condition information stored in the distribution condition management tables 338.

TABLE 1

| | | | | Content | | |
|---|---|---|---|---|---|---|
| | Service | Condition | Type | ID | Version | Range |
| 1 | service-A | 1 | * | * | * | * |
| 2 | Service-B | 2 * 3 | Appli- | B_CLIENT | 2.0 | >= |
| | | | cation | | | |
| 3 | Srv-C | 4 * !5 | Appli- | MPSCLIENT | * | * |
| | | | cation | | | |
| 4 | service-D | (6 + 7) * 8 | FW | * | * | * |
| 5 | Service_E | 9 * 10 | Appli- | E_CLIENT | * | * |
| | | | cation | | | |
| 6 | Service_E | 9 * 10 | Appli- | APP_M | * | * |
| | | | cation | | | |
| 7 | Service_E | 11 * 12 | FW | * | * | * |

Table 1 (distribution condition information) includes a list of combinations of a service, a condition, a type, a content identifier (ID), a version, and a range. “Service” indicates a service which requests a distribution setting subjected to condition determination and is information for identifying the management service 2 (50) and the management service 3 (60). “Condition” indicates a conditional expression for permitting a distribution setting and is a character string which represents a logical expression referring to row numbers of Table 2. “Type” indicates the type of a content (application, FW, etc.) for which a distribution setting is permitted. “Content ID” is information for identifying a content for which a distribution setting is permitted. “Version”, together with “Content ID”, is information for identifying the version of a content for which a distribution setting is permitted. “Range”, together with “Version”, is information for identifying a range of the version of a content for which a distribution setting is permitted. An arbitrary combination of these items in Table 1 on a row basis forms a specific condition for each service. When the specific condition in a certain row is satisfied, a content (range) distribution setting indicated by the row is permitted for the target device. When there is no row in which the condition and content coincide with the distribution setting to be performed from a service, the distribution setting is not permitted but canceled as illustrated in step 470 illustrated in FIG. 6. Although, in the present exemplary embodiment, the distribution setting is permitted when the distribution setting to be performed from a service coincides with the distribution condition, the processing is not limited thereto. Conversely, the distribution setting may not be permitted when the distribution setting to be performed from a service coincides with the distribution condition. More specifically, for each service, the distribution condition needs only to combine the status of a device for which a distribution setting from the service is permitted (or not permitted) with information of a content for which a distribution setting from the service is permitted (or not permitted).

For “Service” in Table 1 according to the present exemplary embodiment, as information for identifying a service which has transmitted a distribution setting request, the name of the service is used. However, in other exemplary embodiments, it is also effective to use the IP address of a connection service and authentication information of a connection service such as the system ID for “Service” in Table 1.

For “Condition”, an expression forming a condition is described using the row number of Table 2 as each term. In the present exemplary embodiment, the logical sum (“+”), the logical product (“*”), the logical negation (“!”), and parentheses (“(”, “)”) for controlling the order of evaluation can be used as logical operators for constituting a conditional expression. A known method for evaluating a logical expression is used, and detailed description thereof will be omitted.

For “Type” according to the present exemplary embodiment, “Application”, “FW” (firmware), or (arbitrary type) can be described as the content type.

For “Content ID”, the ID of an application is described when “Type” is “Application.” To permit distribution of an arbitrary application, “*” is described for “Version”. Also when “Type” is “FW”, “*” is described for “Version”. As other exemplary embodiments, it is also effective to describe an ID which uniquely identifies an application for “Version”.

When “Type” is “FW” or when “Content ID” is a specific application, the version number indicating a specific version is described for “Version”. When permitting an arbitrary version or when permitting an arbitrary content, “*” is described for “Version”. Further, when a specific version is described in a row, describing a comparative operator for “Range” enables representing a range of version with which distribution is permitted with reference to the specific version described in the row. In the present exemplary embodiment, “=”, “>=”, “<=”, “>”, and “<” can be used for “Range”. If “=” is described, distribution is only permitted for the version which coincides with “Version”. If “>=” is described, distribution is permitted for the version indicated by “Version” or later. If “<=” is described, distribution is permitted for the version indicated by “Version” or older. For a later version, “>” is described. For an older version, “<” is described. In a case where a version is an arbitrary version, “*” is described.

TABLE 2

| | Type | Content ID | Version | Range |
|---|---|---|---|---|
| 1 | Embed | ERDS | * | * |
| 2 | Application | B_CLIENT | 2.0 | >= |
| 3 | Embed | ERDS | * | * |
| 4 | Application | MPSCLIENT | * | * |
| 5 | Embed | ERDS | * | * |
| 6 | Application | D_CLIENT | * | * |
| 7 | Application | D_CLIENT_PLUS | * | * |
| 8 | Embed | ERDS | 3.0 | > |

Table 2 (distribution condition information) includes a list of combinations of a type, a content ID, a version, and a range. Each row includes a condition to be confirmed based on information acquired from each distribution setting target device, and indicates an effective built-in function or an installed application. To indicates a built-in function, “Embed” is described for “Type.” To indicate an installed application, “Application” is described for “Type.”

For “Content ID”, the application name is described as identification information of a built-in function to be confirmed or identification information of an application. To indicate a specific version or a range of version, conditions are described in “Version” and “Range.” The notations for “Version” and “Range” are similar to those for the same items of Table 1. With a combination of these items, each row of Table 2 indicates that a specific built-in function is enabled or an application of a specific version or a range of version is installed. More specifically, each row of Table 2 indicates the content installation status and the function enable status which need to be satisfied by each distribution target device, out of distribution conditions. With the combination with Table 1, the setting determination unit 319 determines whether a predetermined built-in function is enabled and whether a predetermined application is installed in the distribution setting target device, and confirms the combination of these pieces of information as a condition. When the condition is satisfied, the setting determination unit 319 permits a distribution setting for the device.

In the present exemplary embodiment, for example, the first row of Table 1 and the first row of Table 2 mean that, in a request from the service indicated by “Service-A”, an arbitrary distribution setting can be permitted if a built-in function “ERDS” is enabled in the target device. In the present exemplary embodiment, “Service-A” in the first row of Table 1 corresponds to the management service (60) illustrated in FIG. 1. The management service 3 (60) is a reliable service generated to transmit to the distribution system 10 only a distribution setting request to the management target device of the management service 3 (60). Therefore, for a distribution setting based on a distribution setting request of the management service 3 (60), an arbitrary distribution setting is permitted if the built-in function “ERDS” is enabled in the management target device.

As another example, the second row of Table 1 and the second and the third rows of Table 2 indicate the following condition in a request from the service indicated by “Service-B”. More specifically, for a device in which the application “B_CLIENT” of version “2.0” or later is installed and the function “ERDS” is enabled, a distribution setting for the application “B_CLIENT” of version “2.0” or later can be permitted.

the third row of Table 1 and the fourth and the fifth rows of Table 2 indicate the following condition in a request from the service indicated by “Srv-C.” More specifically, for a device in which the application “MPSCLIENT” is installed and the function “ERDS” is disabled, a distribution setting only for the application “MPSCLIENT” can be permitted.

In the present exemplary embodiment, the distribution condition management tables 338 are described to have been preregistered. However, the distribution condition management tables 338 may be manually registered and updated when a cooperation between the distribution system 10 and an external system is determined, or automatically updated in association with the automatic registration mechanism of the external system.

FIG. 7 is a flowchart illustrating processing performed by the setting determination unit 319 of the distribution system 10 to determine whether to permit a distribution setting. More specifically, the processing of this flowchart is implemented when the CPU 201 of the distribution system 10 executes a program stored in the HDD 206, the ROM 203 or the like. The processing illustrated in this flowchart is performed for each distribution setting target device.

When the API of a distribution setting request is called from a management service, such as the management service 2 (50) and the management service 3 (60), the distribution system 10 starts the processing from step S1000.

In step S1001, the distribution system 10 registers as a temporary schedule the distribution setting received via the API and returns a response to the caller of API in advance. This step corresponds to step 452 illustrated in FIGS. 5 and 6.

In step S1002, the distribution system 10 identifies the service of the caller of API. According to the identified information, the distribution system 10 recognizes the condition indicated by the row conforming to “Service” in Table 1 as a target of the determination whether the distribution setting is to be permitted.

In step S1003, the distribution system 10 determines whether the latest information has already been acquired from the device (distribution target device) specified by the distribution setting request. More specifically, the distribution system 10 determines whether information about the applications installed in the target device and information about built-in functions enabled in the target device have already been acquired. These pieces of information are updated, for example, in steps 411 and 438 illustrated in FIG. 4 and in step 455 illustrated in FIGS. 5 and 6. In a case where the distribution system 10 determines that these pieces of information have been acquired (YES in step S1003), the processing proceeds to step S1008. Processing in step S1008 and subsequent steps will be described below.

On the other hand, in a case where the distribution system 10 determines that these pieces of information have not been acquired (NO in step S1003), the processing proceeds to step S1004.

In step S1004, the distribution system 10 acquires the latest information (for example, enabled function information or installed application information) from the device. In step S1005, the distribution system 10 determines whether to wait for the acquisition of the latest information from the device (the latest information has not been acquired from the device).

In a case where the distribution system 10 determines to wait for the acquisition of the latest information from the device (the latest information has not been acquired from the device) (YES in step S1005), then in step S1006, the distribution system 10 determines whether the distribution reservation date and time as a temporary schedule has come. In a case where the distribution system determines that the distribution reservation date and time as a temporary schedule has not come (NO in step S1006), the processing returns to step S1004. More specifically, the distribution system 10 waits for the acquisition of the latest information from the device till the distribution reservation date and time as a temporary schedule (YES in step S1006).

In a case where the distribution system 10 determines not to wait for the acquisition of the latest information (the latest information has been acquired from the device) (NO in step S1005) before the distribution reservation date and time as a temporary schedule (NO in step S1006), the processing proceeds to step S1008.

On the other hand, in a case where the distribution system 10 is waiting for the acquisition of the latest information (the latest information has not been acquired from the device) (YES in step S1005) and when the distribution reservation date and time as a temporary schedule comes (YES in step S1006), the processing proceeds to step S1007. In step S1007, the distribution system 10 cancels the distribution reservation registered as a temporary schedule in step S1001 to cancel the distribution setting.

In step S1008, the distribution system 10 determines whether the distribution setting is to be permitted based on (by comparing between) the information acquired from the device and the distribution condition information illustrated in Tables 1 and 2. In step S1009, the distribution system 10 determines whether the distribution setting is to be permitted. In a case where the distribution system 10 determines that the device satisfies the condition and the distribution setting is to be permitted (YES in step S1009), then in S1010, the distribution system 10 applies the distribution setting as illustrated in step 417 illustrated in FIG. 4 or step 456 illustrated in FIG. 5.

On the other hand, in a case where the distribution system 10 determines that the device does not satisfy the condition and the distribution setting is not to be permitted (NO in step S1009), then in step S1007, the distribution system 10 cancels the distribution reservation registered as a temporary schedule and cancels the distribution setting.

Table 3 illustrates an example of application management information stored in the registered application management table 331.

TABLE 3

| | Registration | | Application | | |
|---|---|---|---|---|---|
| | ID | Application ID | name | Version | URL |
| 1 | 1211 | PQR12345 | Print | 1.00 | http://contents-server. . . . |
| | | | management | | |
| | | | tool | | |
| 2 | 1300 | PQR12345 | Print | 2.00 | http://contents-server. . . . |
| | | | management | | |
| | | | tool | | |
| 3 | 1310 | PQR12345 | Print | 3.00 | http://contents-server. . . . |
| | | | management | | |
| | | | tool | | |
| 4 | 1330 | PQR12345 | Print | 3.01 | http://contents-server. . . . |
| | | | management | | |
| | | | tool | | |
| 5 | 1222 | STU12345 | Scan | 2.00 | http://contents-server. . . . |
| 6 | 1212 | LMN12345 | Login | 1.00 | http://contents-server. . . . |

As illustrated in Table 3, the application management information includes a list of combinations of a registration ID, an application ID, an application name, a version, and a URL. An application file of a certain version is uniquely identified by the combination of “Application ID” and “Version” and is stored in a memory on the content server 20 indicated by “URL.” The registered application management information is supplied with a unique registration ID to be identified among the management information. Further, the registered application management information can be supplied with “Application name” to be easily recognized in a display on a user interface. The application management information is input when a person in charge of the sales company system 30 registers an application and is maintained by being updated.

The distribution system 10 also manages combinations of updatable applications to identify versions which can be updated, for example, when updating an application installed in the device for upgrading. Table 4 illustrates an example of combination management information for updatable applications stored in the updatable application management table 332.

TABLE 4

| | Before update | After update |
|---|---|---|
| 1 | 1211 | 1300 |
| 2 | 1300 | 1310 |
| 3 | 1310 | 1330 |
| 4 | 1300 | 1330 |

As illustrated in Table 4, the updatable application management information includes a list of combinations of a registration ID before update and a registration ID after update by using the registration ID managed by the management information illustrated in Table 3. Only when the combination of the registration ID before update (“Before update”) and the registration ID after update (“After update”) in Table 4 exists in the management information illustrated in Table 3, the application can be updated between the two registration IDs. The updatable application management information is input when a person in charge of the sales company system 30 registers an application and is maintained by being updated.

Similar to the case of applications, the distribution system 10 also manages distributable FW. Table 5 illustrates an example of FW management information registered in the registered firmware management table 333.

TABLE 5

| | Device model | Version | URL |
|---|---|---|---|
| 1 | ABC2100 | 10.01 | http://contents-server. . . . |
| 2 | ABC2100 | 11.00 | http://contents-server. . . . |
| 3 | ABC2100 | 11.10 | http://contents-server. . . . |
| 4 | XYZ3000 | 01.00 | http://contents-server. . . . |
| 5 | XYZ3000 | 02.00 | http://contents-server. . . . |
| 6 | XYZ3000 | 10.01 | http://contents-server. . . . |

As illustrated in Table 5, the FW management information includes a list of combinations of a device model, a version, and a URL. A FW file corresponding to the combination of “Device model” and “Version” is stored in the memory on the content server 20 indicated by “URL”. Similar to applications, combinations of updatable FW versions are also managed based on management information (not illustrated). The FW management information is input when a person in charge registers FW from the sales company system 30 and is maintained by being updated.

The distribution system 10 stores and manages the status of each distribution target device. One piece of information indicating the device status is the version information of FW currently operating on each device. Table 6 illustrates an example of device management information stored in the device management table 334.

TABLE 6

| | | | | | Func- | Func- | Func- |
|---|---|---|---|---|---|---|---|
| | | Device | | Customer | tion | tion | tion |
| | Device ID | model | Version | name | A | B | C |
| 1 | ABC111111 | ABC2100 | 10.01 | Oosima | ON | OFF | OFF |
| 2 | DEF222222 | XYZ3000 | 10.01 | Oosima | ON | OFF | OFF |
| 3 | DEF333333 | XYZ3000 | 10.01 | Oosima | OFF | ON | OFF |
| 4 | DEF444444 | XYZ3000 | 10.01 | Oosima | OFF | ON | OFF |
| 5 | DEF444449 | XYZ3000 | 10.01 | Oosima | OFF | OFF | OFF |
| 6 | DEF555555 | XYZ3000 | 10.01 | Oosima | OFF | OFF | OFF |
| 7 | DEF555559 | XYZ3000 | 10.01 | Oosima | OFF | OFF | OFF |

As illustrated in Table 6, the device management information includes a list of combinations of a device ID, a device model, a version, a customer name, and enable flags of various functions. “Model” indicates the model of the device identified by “Device ID”. “Version” indicates the version of the FW currently operating on the device. “Customer name” is the name of a customer who is the owner of the device. “Function A”, “Function B”, and “Function C” indicate functions enabled for each device (“ON” indicates the enable state and “OFF” indicates the disable state). These functions correspond to the content of the “Embed” type in Table 2.

Another information indicating the device status is information about an application installed in each device and the status of the application. Table 7 illustrates an example of installed application information for each device stored in the installed application management table 335.

TABLE 7

| | | | | | Re- | Infor- |
|---|---|---|---|---|---|---|
| | | | | | maining | mation |
| | | | | | number | of |
| | | Application | Ver- | Operating | of | remaining |
| | Device ID | ID | sion | status | licenses | number |
| 1 | ABC111111 | PQR12345 | 3.00 | Activated | 0 | FALSE |
| 2 | ABC111111 | STU12345 | 3.00 | Stopped | 143 | TRUE |
| 3 | DEF222222 | PQR12345 | 3.00 | Unknown | 0 | FALSE |
| 4 | DEF222222 | STU12345 | 3.00 | Stopped | 143 | TRUE |
| 5 | DEF222222 | LMN12345 | 2.00 | Activated | 0 | FALSE |

As illustrated in Table 7, the installed application information includes a list of combinations of a device ID, an application ID, a version, an operating status, remaining number of licenses, and information of remaining number. The combination of “Device ID”, “Application ID”, and “Version” indicates that the application indicated by the combination of “Application ID” and “Version” is installed in the device indicated by “Device ID.” “Operating status” indicates the operating status of the application. “Information of remaining number” is a flag which is “TRUE” when the information about the remaining number of licenses is valid and is “FALSE” when the remaining number of licenses is invalid. “Remaining number of licenses” indicates the remaining number of licenses of applications in the device. When “Information of remaining number” is “FALSE”, the value of “Remaining number of licenses” is not used.

Table 8 illustrates an example of content distribution information stored in the content distribution management table 336.

TABLE 8

| | Distribution | | | | | Distribution | Temporary |
|---|---|---|---|---|---|---|---|
| | ID | Device ID | Type | Content ID | Version | date & time | setting |
| 1 | 234 | ABC111111 | APP | PQR12345 | 3.00 | Dec. 12, 2015 | NO |
| | | | | | | 23:40 | |
| 2 | 237 | DEF222222 | APP | STU12345 | 3.00 | Dec. 12, 2015 | NO |
| | | | | | | 23:40 | |
| 3 | 250 | DEF333333 | APP | PQR12345 | 3.00 | Dec. 12, 2015 | NO |
| | | | | | | 23:40 | |
| 4 | 251 | DEF444444 | APP | STU12345 | 3.00 | Dec. 12, 2015 | YES |
| | | | | | | 23:40 | |
| 5 | 252 | DEF444449 | APP | LMN12345 | 2.00 | Dec. 12, 2015 | YES |
| | | | | | | 23:40 | |

When a distribution setting of a content is registered in response to a request from a management service, the content distribution information as illustrated in Table 8 is updated, and a distribution setting record is added. The contents distribution information includes a list of combinations of a distribution ID, a device ID, a type, a content ID, a version, a distribution date and time, and a temporary setting. For “Distribution ID”, a unique identifier is generated and set when a distribution setting is added with the combination of the remaining columns. “Distribution ID” is returned to a device in step 419 illustrated in FIG. 4 and in step 458 illustrated in FIG. 5 and is specified by a device to identify a distribution setting in step 431 illustrated in FIG. 4.

“Type” indicates the content type (FW or application). “Content ID” indicates the application ID in the case of an application. In a case where a distribution setting is temporarily scheduled, “Temporary setting” becomes “YES.” In a case where a distribution setting is applied, “Temporary setting” is updated to “NO.” In a case where distribution is completed or a distribution setting is canceled, the related record is deleted.

As described above, when performing a content distribution setting on a target device in the distribution system 10 from other than the distribution system 10, for example, from the management service 2 (50), the distribution system 10 determines whether a distribution setting is to be permitted based on information acquired from the target device. This enables preventing a system which has requested the distribution system from unsuitably updating a device not subjected to distribution setting management and the content of the device. Meanwhile, holding conditions by using the distribution condition management tables 338 as illustrated in Tables 1 and 2 enables performing flexible determination, for example, the distribution system permits a distribution setting of an arbitrary content for a reliable system (for example, the management service 3 (60)).

The use of the distribution condition management tables 338 according to the present exemplary embodiment enables setting an exclusive situation of applications and functions, as illustrated in the third row of Table 1. Therefore, referring to this example, it is possible to set such a condition that gives priority to a distribution setting from a service associated with the function “ERDS”.

As described above, by disabling a distribution setting based on the identification information of an external system (for example, the management service 2 (50)) which performs a distribution setting and the information acquired from a distribution setting target device, the distribution system 10 according to the present exemplary embodiment is able to control the reception of requests so that a distribution setting is not performed on devices not subjected to management by the external system.

Therefore, it is possible to prevent a system (external service, etc.) which has requested the distribution system 10 for a distribution setting from unsuitably updating a device not subjected to distribution setting management and the content of the device.

The configuration and the contents of the above-described various data are not limited thereto. Diverse configurations and contents may be used according to applications and purposes.

Although the present disclosure has been described above based on one exemplary embodiment, the present disclosure can be embodied, for example, as a system, an apparatus, a method, a program, or a storage medium. More specifically, the present disclosure is applicable to a system composed of a plurality of apparatuses and to an apparatus composed of one device.

All of configurations derived by suitably combining the above-described exemplary embodiments are also encompassed in the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2015-237128, filed Dec. 4, 2015, which is hereby incorporated by reference herein in its entirety.

What is claimed is:

1. A distribution system for controlling distribution of a content to a device according to a distribution setting requested from one or more of services which manages devices, the distribution system comprising:
a first receiving unit configured to receive a request of a distribution setting for a content from a service capable of communicating via a network;
a determination unit configured to, in a case where the first receiving unit receives the request for the content from the service, determine whether to permit the distribution setting based on information of the service which has requested the distribution setting, a status of a content distribution target device of the distribution setting, and a distribution condition set in advance; and
a control unit configured to perform control, in a case where the determination unit determines to permit the distribution setting, to apply the distribution setting, and to perform control, in a case where the determination unit determines not to permit the distribution setting, to cancel the distribution setting.

2. The distribution system according to claim 1, further comprising:
a second receiving unit configured to provide a user interface via a network to receive a distribution setting from a user; and
a data sharing unit configured to receive a list of devices from a specific service, wherein the specific service has a cooperation function for transmitting, to the data sharing unit, the list of devices specified from among devices managed by the specific service;
wherein, the control unit applies, in a case where the data sharing unit receives the list of devices and a distribution setting of a content to be distributed to the devices specified in the list of devices is received using the user interface, the distribution setting without determination by the determination unit.

3. The distribution system according to claim 1,
wherein the distribution condition is set for each service and is a combination of a status of a device with which a distribution setting from a corresponding service is permitted or not permitted and information of a content, and
wherein the determination unit performs determination by comparing the distribution condition with a combination of information about the service which has requested the distribution setting, a status of the content distribution target device for in the distribution setting, and information about the content to be distributed based on the distribution setting.

4. The distribution system according to claim 1, wherein the status of the device includes an installation status of a content in the device.

5. The distribution system according to claim 1, wherein a status of the device includes an enable status of a function in the device.

6. The distribution system according to claim 1, wherein, in a case where a status of the device cannot be acquired by a date and time received by the first receiving unit and specified in a distribution setting, the determination unit determines not to permit the distribution setting.

7. A control method in a distribution system for controlling distribution of a content to a device according to a distribution setting requested from one or more of services which manages devices, the method comprising:
receiving a request of a distribution setting for the content from a service capable of communicating via a network;
determining, in a case where the request for the content is received from the service, whether to permit the distribution setting based on information of the service which has requested the distribution setting, a status of a content distribution target device of the distribution setting, and a distribution condition set in advance; and
performing control, in a case where the distribution setting is determined to be permitted, to apply the distribution setting, and to performing control, in a case where the distribution setting is determined not to be permitted, to cancel the distribution setting.
